(19) United States
(12) Patent Application Publication
(10) Pub. No.: US 2009/0219079 A1
(43) Pub. Date: Sep. 3, 2009

(54) CHARGE PUMP CIRCUIT FOR RFID INTEGRATED CIRCUITS

(75) Inventors: Ewald Bergler, Weiz (AT); Roland Brandl, Eggersdorf Bei Graz (AT); Robert Spindler, Graz (AT)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/065,012

(22) PCT Filed: Aug. 24, 2006
(86) PCT No.: PCT/IB2006/052939

§ 371 Date: Oct. 24, 2008

(30) Foreign Application Priority Data
Sep. 2, 2005 (EP) 05108036.4
Aug. 24, 2006 (IB) PCT/IB2006/052939

(51) Int. Cl. G05F 1/10

(52) U.S. Cl. 327/536

(57) ABSTRACT

An exemplary embodiment of the invention provides a charge pump stage (100) that comprises a first input node (101), a second input node (107), a decoupling capacity (109) having a first terminal (108) and a second terminal (110). Further, the charge pump stage (100) comprises a pump control circuit having a first contact node (102) and a second contact node (111), wherein the first input node (101) is coupled to the first contact node (102). Furthermore, the second input node (107) is coupled to the first terminal (108) of the decoupling capacity (109), and the second terminal (110) of the decoupling capacity (109) is coupled to the second contact node (111) and further coupled to ground (112).

The invention relates to the field of charge pumps. In particular, the invention relates to charge pumps for Ultra High Frequency Radio Frequency IDentification Integrated Circuits (UHF-RFID-IC).

UHF-RFID-ICs generally needs a power source for operation. The power source usually comprises a so-called charge pump or voltage multiplier boosting a low voltage power supply. One requirement for the power supply is generally that DC levels are blocked, so that the RFID-IC suffers no malfunction due to a possible DC level. This is in particular the case since UHF-RFID-ICs are operated with a loop antenna. In general the blocking is done by providing a series capacity in the RF branch of the RFID-IC.

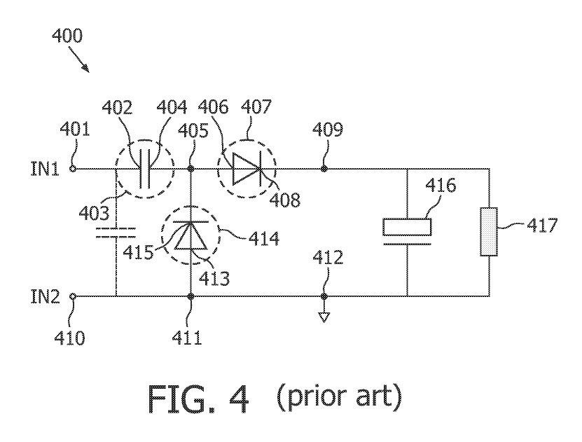

A standard voltage multiplier or charge pump is schematically shown in FIG. 4. FIG. 4 shows a voltage multiplier 400 having a first input node 401, the first input node 401 is coupled to a first terminal 402 of a capacity 403. A second terminal 404 of the capacity 403 is coupled to a first circuit node 405. The first circuit node 405 is coupled to an anode 406 of a first diode 407, while a cathode 408 of the first diode 407 is coupled to a first output node 409. The first input node 401, the capacity 403, the first diode 407 and the first output node 409 form a first branch of the charge pump 400, the so-called RF-branch.

A second input node 410 is coupled to a second circuit node 411 which is coupled to a second output node 412 which is connected to ground. Further, the second circuit node 411 is coupled to an anode 413 of a second diode 414. A cathode 415 of the second diode 414 is coupled to the first circuit node 405. The second input node 410 and the second circuit node 411, and the second output node 412 form a second branch of the charge pump, the so-called lower-branch.

In operation of the charge pump 400 an alternating current or voltage can be applied to the first input node 401 and the second input node 411. That is a voltage difference of Uₑ exists between the both input nodes. Further, a voltage drop of U_{f} occurs over the second diode 414 which corresponds to the so-called forward voltage of the diode. Thus, the capacity in the RF-branch is charged with a voltage Uₑₛ−U_{f}, wherein U_{ef} represent the peak value of the alternating voltage Uₑ. In operation this voltage the capacity is charged with is added to the peak value U_{ef}, thus leading to a “multiplied” voltage, while the forward voltage of the diode is lost.

The total voltage of the charge pump 400 which is provided between the first output 407 node and the second output node 413 is

U_{Q}=Ûₑ+(Ûₑ−U_{f})−U_{f} [symbol] U_{Q}=2Ûₑ−2U_{f}.

Furthermore, in FIG. 4 a parasitic capacitance is depicted with the dotted lines. This parasitic capacitance occurs with respect to a substrate the charge pump is formed on, when the charge pump is operated with alternating current. In an equivalent circuit diagram this parasitic capacitance can be outlined as a capacitance coupled between the first branch and the second branch of the charge pump.

Furthermore, a storage capacity, or so-called smoothing capacity, 416 and a resistive load 417 are schematically shown in FIG. 4, wherein the storage capacity 416 and the resistive load are coupled between the first output node 409 and the second output node 412.

A low power charge pumped DC bias supply similar to the one shown in FIG. 4 is disclosed in U.S. Pat. No. 6,396,724.

An exemplary embodiment of the invention provides a charge pump stage comprises a first input node, a second input node, a decoupling capacity having a first terminal and a second terminal. Further, the charge pump stage comprises a pump control circuit having a first contact node and a second contact node, wherein the first input node is coupled to the first contact node. Furthermore, the second input node is coupled to the first terminal of the decoupling capacity, and the second terminal of the decoupling capacity is coupled to the second contact node and further coupled to ground.

A characteristic feature according to the present invention may be that a decoupling capacitance of a charge pump according to the present invention is coupled into the so-called lower branch, i.e. the branch which is coupled to ground, instead of coupling it into the RF-branch as it is in charge pumps according to the known state of the art. Thus, the decoupling capacitance, also called first capacity, may be coupled directly to ground. This kind of coupling may lead to the fact that unavoidable parasitic capacities of the charge pump are added to the implemented capacity, i.e. the decoupling capacity. Thus, these capacities may now be useful since the decoupling capacity can be designed smaller. Further, it might be possible that the matching of the antenna circuitry is getting easier when a charge pump according to the present invention is used. Furthermore, it might be possible that the effect of the parasitic capacities on the efficiency of the voltage multiplier is reduced, when a charge pump according to the present invention is used.

Furthermore, the so-called Q-factor, i.e. the figure of merit, of the decoupling capacity, also called series capacity, has a big influence on the efficiency of the charge pump. The Q-factor can be calculated as Q=X_{c}/Rₛ, wherein X_{c} is the series reactance and Rₛ is the series resistance of the capacity. In general there is always a trade off between parasitic capacity and series resistance in order to achieve a good Q-factor. Since the parasitic capacity may be added to the implemented decoupling capacity in a charge pump according to present invention this trade off may not be a hard limit anymore.

Referring to the dependent claims, further preferred embodiments of the invention will be described in the following.

Next, preferred exemplary embodiments of the charge pump stage of the invention will be described. These embodiments may also be applied for a multi-stage charge pump.

In another exemplary embodiment the pump control circuit of the charge pump stage further comprises a third contact node and a fourth contact node which are adapted to form a first output node and a second output node.

In a further exemplary embodiment the pump control circuit further comprises a first diode, coupled between the first contact node and the second contact node.

In yet another exemplary embodiment the pump control circuit further comprises a second diode.

In still another exemplary embodiment of the charge pump stage the second diode is coupled between the first contact node and the third contact node.

In an exemplary embodiment a multi-stage charge pump comprising a plurality of charge pump stages, wherein at least one charge pump stage is formed according to an charge pump stage according to the present invention.

In another exemplary embodiment the multi-stage charge pump further comprising a switching element, which is coupled between different stages of the plurality of charge pump stages.

In yet another exemplary embodiment of the multi-stage charge pump the switching element is coupled into the multi-stage charge pump in such a way that a supply voltage provided by the charge pump is not multiplied.

In yet still another exemplary embodiment of the multi-stage charge pump the switching element comprises a transistor and/or a MOS-diode.

In an exemplary embodiment an RFID-tag comprises at least one charge pump stage according to the present invention or comprises a multi-stage charge pump according to the present invention.

The present invention may be of particular interest in the field of RFID tags, since it may provide an effective power source for an RFID tag.

A characteristic feature according to the present invention may be that while according to the prior art a decoupling capacity is coupled into the RF-branch of a charge pump, i.e. the branch having a high voltage level, the decoupling capacity of a charge pump according to the present invention is shifted into the lower branch, i.e. the branch having a low voltage level and/or is coupled directly to ground potential, instead. Therefore, one terminal of the decoupling capacity may be coupled directly to ground, i.e. to ground potential. Thus, unavoidable parasitic capacities, generated by the charge pump circuit with respect to ground are added to the implemented decoupling capacity. Thus, these capacities may now be useful since the decoupling capacity may be designed smaller and the Q-factor of the decoupling capacity may be increased without the limitation of the trade off between the parasitic capacity of the pump circuit and the series resistance of the decoupling capacity. The input nodes of the charge pump stage or the multi-stage charge pump according to the present invention may be coupled to a loop antenna. This may in particular advantageous if the charge pump is used in connection with an RFID-tag.

The aspects defined above and further aspects of the invention are apparent from the examples of embodiment to be described hereinafter and are explained with reference to the examples of embodiment.

The invention will be described in more detail hereinafter with reference to examples of embodiment but to which the invention is not limited.

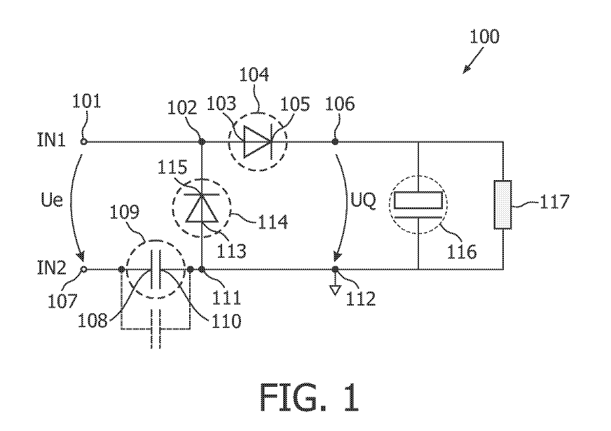

FIG. 1 schematically shows a charge pump stage according to an embodiment of the present invention,

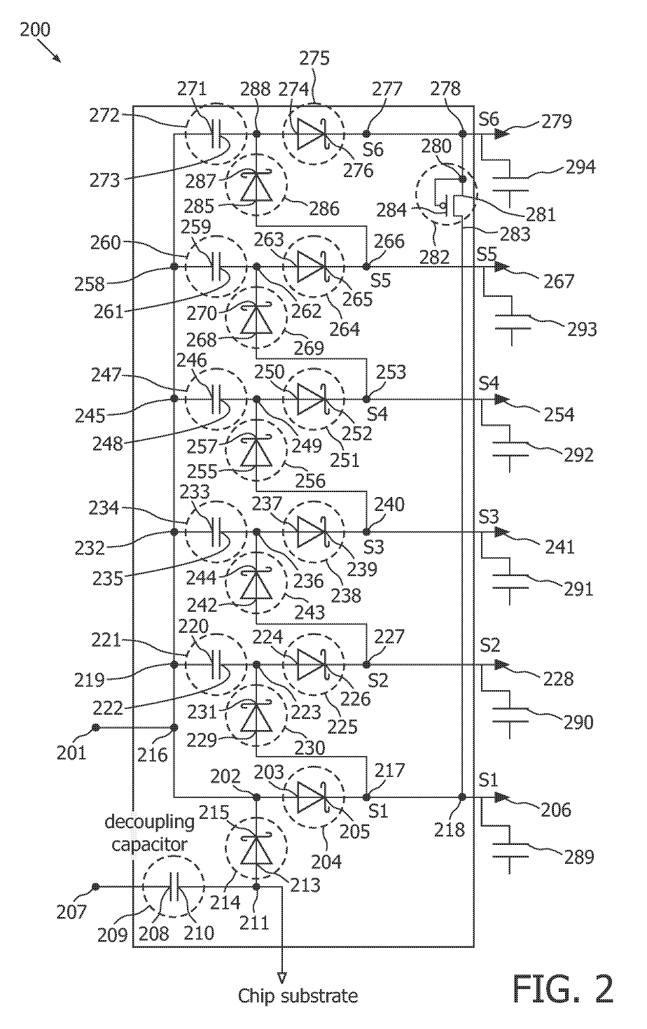

FIG. 2 schematically shows a multi-stage charge pump according to an embodiment of the present invention,

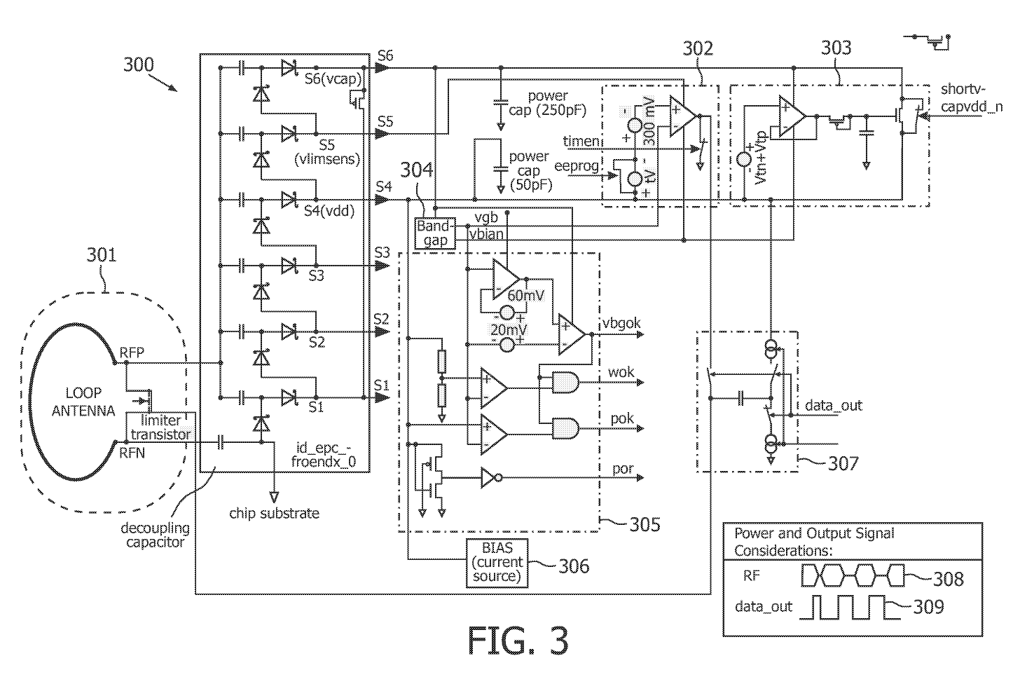

FIG. 3 schematically shows a RFID tag comprising a multi-stage charge pump according to the embodiment of FIG. 2, and

FIG. 4 schematically shows a charge pump according to the prior art.

The illustration in the drawing is schematically. In different drawings, similar or identical elements are provided with the same or similar reference signs.

In the following, referring to FIG. 1, a charge pump stage according to an embodiment of the invention is described. FIG. 1 shows a voltage multiplier 100 having a first input node 101, the first input node 101 is coupled to a first circuit node 102. The first circuit node 102 is coupled to an anode 103 of a first diode 104, while a cathode 105 of the first diode 104 is coupled to a first output node 106. The first input node 101, the first diode 104 and the first output node 106 form a first branch of the charge pump 100, the so-called RF-branch.

A second input node 107 is coupled to a first terminal 108 of a capacity 109, which forms a decoupling capacity of the charge pump 100. A second terminal 110 of the capacity 109 is coupled to a second circuit node 111, which is coupled to a second output node 112 and further coupled to ground. Thus, the second terminal 110 of the capacity 109 is directly coupled to ground potential. Further the second circuit node 111 is coupled to an anode 113 of a second diode 114. A cathode 115 of the second diode 114 is coupled to the first circuit node 102. The second input node 107, the capacity 109, and the second circuit node 111, and the second output node 112 form a second branch of the charge pump, the so-called lower-branch. Additionally in FIG. 1 a storage capacity, or so-called smoothing capacity, is schematically shown as 116 which is coupled between the first output node 106 and the second output node 112. Furthermore, a load 117 is schematically shown in FIG. 1 as a resistive load. The load 117 is coupled between the first output node 106 and the second output node 112, i.e. parallel to the storage capacity 116. This load may be an RFID tag.

In operation of the charge pump 100 an alternating current or voltage can be applied to the first input node 101 and the second input node 107. That is a voltage difference of Uₑ exists between the both input nodes. Further, a voltage drop of U_{f} occurs over the second diode 113 which voltage drop corresponds to the so-called forward voltage of the diode. Thus, the capacity in the lower-branch is charged with a voltage Uₑₛ−U_{f}, wherein U_{ef} represent the peak value of the alternating voltage Uₑ. In operation this voltage, the capacity is charged with, is added to the peak value U_{ef}, thus leading to a “multiplied” voltage.

The total voltage of the charge pump 100 which is provided between the first output 106 node and the second output node 113 is

U_{Q}=Ûₑ+(Ûₑ−U_{f})−U_{f} [symbol] U_{Q}=2Uₑ−2U_{f}.

Furthermore, in FIG. 1 a parasitic capacitance is depicted with the dotted lines. This parasitic capacitance occurs with respect to a substrate the charge pump is formed on, when the charge pump is operated with alternating current. In an equivalent circuit diagram this parasitic capacitance can be outlined as a capacitance coupled in parallel to the decoupling capacity 109.

In the following, referring to FIG. 2, a multi-stage charge pump according to an embodiment of the invention is described. FIG. 2 shows a multi-stage voltage multiplier 200 having a first input node 201, the first input node 201 is coupled to a third circuit node 216 which is coupled to a first circuit node 202. The first circuit node 202 is coupled to an anode 203 of a first diode 204, while a cathode 205 of the first diode 204 is coupled to a fourth circuit node 217. The fourth circuit node 217 is coupled to a fifth circuit node 218 which is coupled to a first output node 206.

A second input node 207 is coupled to a first terminal 208 of a capacity 209, which forms a decoupling capacity of the multi-stage charge pump 200. A second terminal 210 of the capacity 209 is coupled to a second circuit node 211, which is coupled to ground. Further the second circuit node 211 is coupled to an anode 213 of a second diode 214. A cathode 215 of the second diode 214 is coupled to the first circuit node 202. The second input node 207, the capacity 209, and the second circuit node 211, form the so-called lower-branch of the charge pump 200.

The above described elements of the multi-stage charge pump 200 form a first stage of the multi-stage charge pump.

The third circuit node 216 is coupled to a sixth circuit node 219 which is coupled to a first terminal 220 of a second capacity 221. A second terminal 222 of the second capacity 221 is coupled to a seventh circuit node 223, which is coupled to an anode 224 of a third diode 225. A cathode 226 of the third diode 225 is coupled to an eighth circuit node 227 which is coupled to a second output node 228.

The fourth circuit node 217 is further coupled to an anode 229 of a fourth diode 230. A cathode 231 of the fourth diode 230 is coupled to the seventh circuit node 223.

The elements of the multi-stage charge pump 200 described in the last two paragraphs form a second stage of the multi-stage charge pump.

The sixth circuit node 216 is coupled to a ninth circuit node 232 which is coupled to a first terminal 233 of a third capacity 234. A second terminal 235 of the third capacity 234 is coupled to a tenth circuit node 236, which is coupled to an anode 237 of a fifth diode 238. A cathode 239 of the fifth diode 238 is coupled to an eleventh circuit node 240 which is coupled to a third output node 241.

The eight circuit node 227 is further coupled to an anode 242 of a sixth diode 243. A cathode 244 of the sixth diode 243 is coupled to the tenth circuit node 236.

The elements of the multi-stage charge pump 200 described in the last two paragraphs form a third stage of the multi-stage charge pump.

The ninth circuit node 232 is coupled to a twelfth circuit node 245 which is coupled to a first terminal 246 of a fourth capacity 247. A second terminal 248 of the fourth capacity 247 is coupled to a thirteenth circuit node 249, which is coupled to an anode 250 of a seventh diode 251. A cathode 252 of the seventh diode 251 is coupled to an fourteenth circuit node 253 which is coupled to a fourth output node 254.

The eleventh circuit node 240 is further coupled to an anode 255 of an eighth diode 256. A cathode 257 of the eighth diode 256 is coupled to the thirteenth circuit node 249.

The elements of the multi-stage charge pump 200 described in the last two paragraphs form a fourth stage of the multi-stage charge pump.

The twelfth circuit node 245 is coupled to a fifteenth circuit node 258 which is coupled to a first terminal 259 of a fifth capacity 260. A second terminal 261 of the fifth capacity 260 is coupled to a sixteenth circuit node 262, which is coupled to an anode 263 of a ninth diode 264. A cathode 265 of the ninth diode 264 is coupled to an seventeenth circuit node 266 which is coupled to a fifth output node 267.

The fourteenth circuit node 253 is further coupled to an anode 268 of a tenth diode 269. A cathode 270 of the tenth diode 269 is coupled to the sixteenth circuit node 262.

The elements of the multi-stage charge pump 200 described in the last two paragraphs form a fifth stage of the multi-stage charge pump.

The fifteenth circuit node 258 is coupled to a first terminal 271 of a sixth capacity 272, A second terminal 273 of the sixth capacity 272 is coupled to an eighteenth circuit node 288, which is coupled to an anode 274 of an eleventh diode 275. A cathode 276 of the eleventh diode 275 is coupled to a nineteenth circuit node 277 which is coupled to a twentieth circuit node 278 which is coupled to a sixth output node 279. The twentieth circuit node 278 is further coupled to a twenty first circuit node 280 which is coupled to a first source/drain electrode 281 of a first transistor 282. A second source/drain electrode 283 of the first transistor 282 is coupled to the fifth circuit node 218. The twenty first circuit node 280 is further coupled to a gate 284 of the first transistor 282. Using this coupling the first transistor 282 is operated as a so-called MOS-diode.

The seventeenth circuit node 266 is further coupled to an anode 285 of a twelfth diode 286. A cathode 287 of the twelfth diode 286 is coupled to the eighteenth circuit node 288.

The elements of the multi-stage charge pump 200 described in the last two paragraphs form a sixth stage of the multi-stage charge pump.

In operation of the multi-stage charge pump 200 an alternating current or voltage can be applied to the first input node 201 and the second input node 207. That is a voltage difference of Uₑ exists between the both input nodes. Accordingly, a voltage having substantially the value of 2*Uₑ (not considered the forward voltage of the diodes) is provided at the first output node 206. A voltage having substantially the value of 3*Uₑ is provided at the second output node 228. A voltage having substantially the value of 4*Uₑ is provided at the third output node 241. A voltage having substantially the value of 5*Uₑ is provided at the fourth output node 254. A voltage having substantially the value of 6*Uₑ is provided at the fifth output node 267. A voltage having substantially the value of 7*Uₑ is provided at the sixth output node 279.

Furthermore, the multi-stage charge pump 200 comprises several storage capacities which are coupled to respective charge pump stages of the multi-stage charge pump 200. A first storage capacity 289 is coupled to the first output node 206. A second storage capacity 290 is coupled to the second output node 228. A third storage capacity 291 is coupled to the third output node 241. A fourth storage capacity 292 is coupled to the fourth output node 254. A fifth storage capacity 293 is coupled to the fifth output node 267 and a sixth storage capacity 294 is coupled to the sixth output node 279.

Using these output voltages of the multi-stage charge pump 200, for example, an RFID-tag can be supplied with power. A system of the multi-stage charge pump according to the present invention and an RFID-tag is schematically shown in FIG. 3.

The multi-stage charge pump according to the present invention may be used as a power supply for a common RFID tag, which is schematically shown in FIG. 3. In the following, referring to FIG. 3, an RFID tag comprising a multi-stage charge pump 300 according to the embodiment of FIG. 2 is shown. The input nodes of the multi-stage charge pump are connected to a loop antenna circuit 301 schematically shown in FIG. 3. The loop antenna circuit comprises a limiter transistor which limits the voltage supplied from the loop antenna. As in FIG. 2 the multi-stage charge pump comprises a MOS-diode which can be used to supply the net V_{cap}, i.e. the net voltage falling off at output node labelled S4 in FIG. 3, directly from RFP, i.e. the RF positive voltage of the loop antenna circuit, in case of DC operation where no charge pump is activated.

Output nodes of the multi-stage charge pump 300 are connected to a parallel regulator 302 which primarily controls the supply voltage V_{dd} to a voltage level of about 1.5 V. Furthermore, the supply voltage V_{dd} is raised at least to the minimum write voltage of about 1.8 V during a write command execution. This raising leads to a different read and write distance of the tag.

The output nodes of the multi-stage charge pump 300 are further connected to a linear or series regulator 303. The linear regulator 303 comprises a capacity, which forms a storage capacity to ensure relative constant potential and therefore a constant V_{dd}. That is, the storage capacity may compensate a voltage drop due to an amplitude modulation of the field (AFK) in order to change information with a reader reading the RFID-tag.

The RFID tag schematically shown in FIG. 3 further comprises a bandgap circuit 304. The bandgap circuit is connected to the output node S6 of the multi-stage charge pump. Thus, the bandgap circuit 304 is supplied via V_{cap} which has an inherit startup behaviour.

Output of the bandgap circuit 304 is supplied to a logic circuit 305 which generate some logic output signals like POR (Power-on Reset), POK (Power OK), and WOK (Writing OK). For generate these signals the logic circuit 305 is further connected to output nodes (S4 and S6) of the multi-stage charge pump and is supplied by a Bias, i.e. a current source, 306. Furthermore, output of the bandgap circuit 304 is further supplied to the parallel regulator 302 and to the linear regulator 303.

Furthermore, the RFID tag of FIG. 3 comprises an output circuit 307 which generate the data output signal of the RFID tag. For this the output circuit 307 is connected to outputs of the parallel regulator 302 and to one output node (S4) of the multi-stage charge pump. The output circuit 307 comprises a so-called pump section comprising a capacity and current sources, to ensure enough limiter gate voltage for backscatter operation even in less power situations. Therefore, the output circuit 307 is connected also to the limiter transistor of the loop antenna. Due to the securing of enough limiter gate voltage no large limiter transistor has to be used, i.e. a smaller limiter transistor can be used. The steepness of voltage ramps in the output circuit 307 may be controlled via EEbits.

Furthermore, in the lower right of FIG. 3 power and output signal considerations are schematically shown. A first line 308 shows the RF signal, i.e. the power signal, while a second line 309 shows the corresponding baseband data signal which is labelled data_out. The data output signal is a rectangular signal between V_{dd} and 0 V.

The abbreviations used in FIG. 3 are:
RFP: RF positive voltage
RFN: RF negative voltage
V_{dd}: Positive supply voltage
Vₗᵢₘₛₑₙₛ: limiting voltage
V_{cap}: capacity voltage (maximum voltage of the charge pump)
Limen: Enabling signal (i.e. a signal to enable or disable the parallel regulator for test purposes)
EEprog: digital control signal (signal which indicates a programming cycle on the EEPROM within a communication frame)
Shortvcapvdd_n: Element for shorting V_{cap} and V_{dd}. (used for test purposes)
V_{bg}: Bandgap voltage
V_{bian}: negative bias voltage
V_{bg}OK: Bandgap voltage OK
WOK: Writing OK
POK: Power OK
POR: Power-on Reset

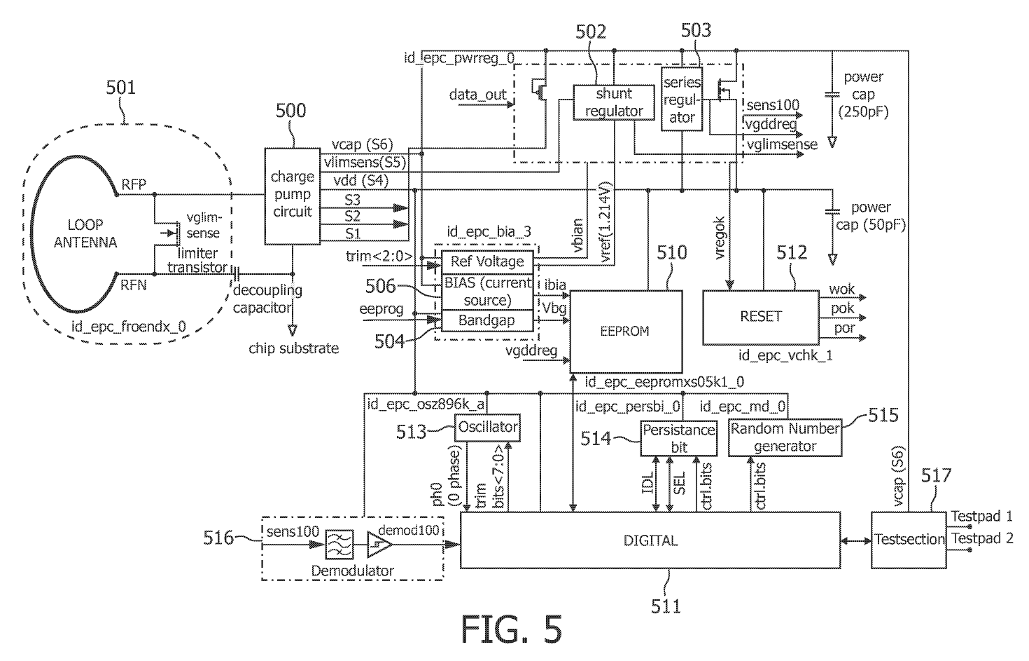

A system of a multi-stage charge pump according to the present invention and an a similar RFID-tag as shown in FIG. 3 is schematically shown in FIG. 5 in which system elements having similar functions are labelled with similar or identical reference signs or words.

The coupling of the system comprising the multi-stage charge pump and the RFID-tag is shown in FIG. 5. In particular, the system comprises a loop antenna circuit 501 coupled to a multi-stage charge pump 500. The multi-stage charge pump is coupled to a shunt (parallel) regulator 502 and to a series (linear) regulator 503. Furthermore, the RFID-tag of FIG. 5 also comprises a Bias 506, i.e. a current source, and a bandgap circuit 504. The system further comprises an EEPROM unit 510 which is coupled between the multi-stage charge pump 500 and the Bias 506 respectively between the multi-stage charge pump 500 and the bandgap circuit 504 and which EEPROM unit is in bidirectional communication with a digital unit 511. The system further comprises a reset unit 512 which is also coupled to the multi-stage charge pump 500 and which provides a WOK-signal, a POK-signal and a POR-signal. Furthermore, the system comprises an oscillator 513 a persistence-bit unit 514, a random number generator 515, and a demodulator 516 which are all coupled to the positive voltage supply of the multi-stage charge pump 500 and which are in uni- or bidirectional communication with the digital unit 511, as indicated by the arrows in FIG. 5. As another component the system shown in FIG. 5 comprises a testsection which is coupled to the sixth stage of the multi-stage charge pump 500 and is in bidirectional communication with the digital unit 511, Furthermore, this testsection 517 is connectable to a plurality of testpads which are schematically shown as “Testpad 1” and “Testpad 2” in FIG. 5.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. A charge pump stage comprising:
a first input node,
a second input node,
a decoupling capacity having a first terminal and a second terminal, and
a pump control circuit having a first contact node and a second contact node,
wherein the first input node is coupled to the first contact node,
wherein the second input node is coupled to the first terminal of the decoupling capacity,
wherein the second terminal of the decoupling capacity is coupled to the second contact node and further coupled to ground.

2. The charge pump circuit according to claim 1, wherein the pump control circuit further comprises a third contact node and a fourth contact node which are adapted to form a first output node and a second output node.

3. The charge pump stage according to claim 1, wherein the pump control circuit comprises a first diode, coupled between the first contact node and the second contact node.

4. The charge pump stage according claim 3, wherein the pump control circuit further comprises a second diode.

5. The charge pump stage according to claim 4, wherein the second diode is coupled between the first contact node and the third contact node.

6. A multi-stage charge pump comprising a plurality of charge pump stages, wherein at least one charge pump stage is formed according to claim 1.

7. The multi-stage charge pump according to claim 6, further comprising a switching element, which is coupled between different stages of the plurality of charge pump stages.

8. The multi-stage charge pump according to claim 7, wherein the switching element is coupled into the multi-stage charge pump in such a way that a supply voltage provided by the charge pump is not multiplied.

9. The multi-stage charge pump according to claim 7, wherein the switching element comprises a transistor and/or a MOS-diode.

10. An RFID-tag comprising at least one charge pump stage according to a claim 1.

11. An RFID-tag comprises at least one multi-stage charge pump according to claim 6.
